(19) United States
(12) Patent Application Publication
(10) Pub. No.: US 2006/0215929 A1
(43) Pub. Date: Sep. 28, 2006

(54) Methods and apparatus for image convolution

(76) Inventors: David Fresneau, St Germain en Laye (FR); Didier Le Maitre, Antony (FR); Philippe Gautier, Sceaux (FR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/087,313

(22) Filed: Mar. 23, 2005

(51) Int. Cl. G06K 9/64

(52) U.S. Cl. 382/279

(57) ABSTRACT

Methods and apparatus for image convolution using a one dimensional convolution operator to perform two successive convolutions, one in one dimension and one in a second dimension. A one dimensional convolution operator is provided with convolution coefficients and image data from a data matrix, and may also be provided with offset information, and stores the result of convolution in a first dimension in a buffer. Then for convolution in the second dimension, the results of the first convolution stored in the buffer are coupled back to the convolution operator for convolution in the second dimension. In a preferred embodiment, the result of the convolution in the second dimension for each of three color components is directed to an output buffer that selectively will provide as the output, the pixel data after the two dimensional convolution or the original pixel data. Alternate forms of convolution coefficients are disclosed.

### BACKGROUND OF THE INVENTION

1. Field of the Invention

The present invention relates to the field of color image processing, and more specifically to the application of convolution operations on color images.

2. Prior Art

A well-known challenge in color printers is that of printing the image in a form that is as true to the original as possible. The image is usually reproduced as a sequence of dots having a certain color, attempting to achieve a continuous tone color. However, as these dots are discrete, noise is introduced causing the printed material to be less than faithful to the original. The noise can be described, for all practical purposes, as a relatively high frequency and therefore a low-pass filter may be used to prevent such disturbances. However, in some cases it is necessary to emphasize, or sharpen edges, which is of special importance when printing characters, and especially characters of small point sizes.

Convolution operators are useful for the purpose of applying filters on images. As noted above, these include filters such as low pass filters to eliminate noise, or edge enhancement filters to sharpen borders of images. Convolution operators are commonly used in many color processing systems where image processing is needed in multi-function printers, digital color copiers, printers, scanners and more.

When convolution operations are used in printers, and in particularly in LASER printers, it is essential that the convolution operation be performed at engine speed. This is an increasing challenge as the printing speed, normally measured in pages per minute (ppm), increases. To print at the maximum print engine speed is desirable for efficient use of the printer. On the other hand, any implementation must be a practical solution for a mass-market. Solutions such as suggested in U.S. Pat. Nos. 6,405,185 and 6,049,859 do exist. However, they rely on a plurality of processing elements arranged as a parallel array of processors, and at times massive parallelism is in fact used. These are costly solutions and are not practical for stand-alone consumer or mass-market commercial applications.

It would therefore be advantageous to provide a solution that will provide significant performance for convolution operations while maintaining the solution within the practical constraints of a controller for a commercial application of a stand-alone printer.

### BRIEF DESCRIPTION OF THE DRAWINGS

FIG. 1 is an exemplary block diagram of a separable convolution processing unit (SCPU) in accordance with an embodiment of the present invention.

FIG. 2 is a schematic block diagram of an exemplary embodiment of the Convolution Operator of the SCPU.

FIG. 3 is an exemplary 5×5 coefficient map for use with an SCPU.

FIG. 4 is a schematic block diagram of the Middle Buffer of the SCPU.

FIG. 5 is a generic representation of a 5×5 matrix of byte values for each color component of each pixel as centered on a center value 3,3.

FIG. 6 is a 5-by-5 coefficient matrix for an alternate embodiment of the present invention.

### DETAILED DESCRIPTION OF THE PREFERRED EMBODIMENTS

A practical convolution operator for implementation in conjunction with a fast printer engine should provide, on one hand, high performance, and on the other hand, be sensitive to implementation costs. To that effect, the inventors have noted that for a two dimensional (2D) color printer convolution operator, it is possible to perform the convolution in two steps, each time in one direction, i.e., horizontal or vertical. The result of the two-step processing, for example horizontal convolution followed by a vertical convolution, is equivalent to a 2D convolution operation. While requiring another step in the processing, there is a significant reduction in resources required, as a single dimension convolution operator is used twice, allowing for a practical controller implementation.

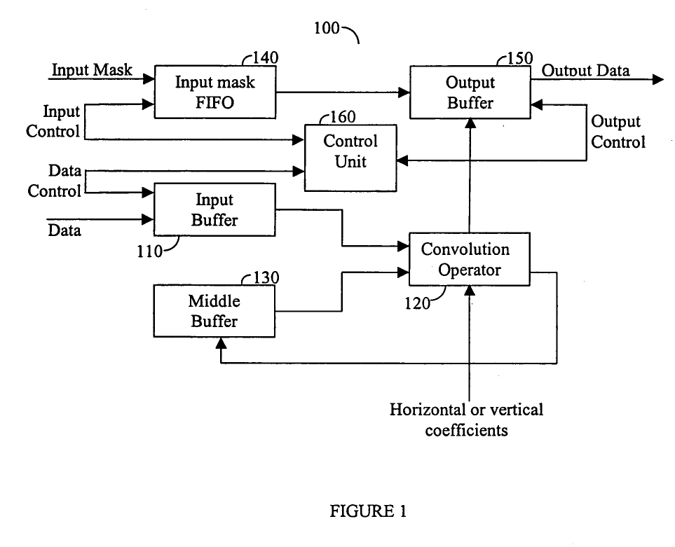

Reference is now made to FIG. 1 where an exemplary and non-limiting block diagram of a separable convolution processing unit (SCPU) 100 in accordance with an embodiment of the invention is shown. SCPU 100 is comprised of an Input Buffer 110, a one-dimensional Convolution Operator 120 controlled by Control Unit 160, a Middle Buffer 130 controlled by a Middle Buffer Manager 410, an input mask first in first out (FIFO) 140, and an Output Buffer 150. The following description assumes an exemplary 5-by-5 pixel implementation of the invention. However, a person skilled in the art could easily implement the invention for other 2n+1 by 2n+1 configurations with ‘n’ equal one, two, three and so on.

Input Buffer 110 is designed to save enough data to begin a vertical convolution. For a five pixel convolution (5×5 convolution matrix), five lines are necessary. The input interface over which data is supplied to Input Buffer 110, may be, for example, sixty four bits wide. Such widths may be typically found in imaging devices to allow for as high data throughput as practically possible. However, such width, larger or smaller, will only effect performance of the device rather then its operability. In the particular example, registers adequate to hold five lines of data are provided, each being 64 bits wide. Assuming 8 bits for each of three colors per pixel, each 64 bits represents two pixels plus two additional bytes for two colors of an adjacent pixel(s). This data therefore represents five lines, but less than five pixels per line. When a 64 bit word for each of five lines of data have been received in the Input Buffer 110, further input is temporarily halted.

A person skilled in the art could easily balance between the bus size, processing capabilities of the system, and the available bandwidth to allow for smooth execution. Input Buffer 110 is controlled using the control inputs which provide input control signals at least for: a) the purpose of indicating that input data is valid; and, b) stalling Input Buffer 110 as may be necessary. Loading of the Input Buffer 110 is done under program control to provide the desired 64 bit words in the desired order to provide five-line data, when required, centered on each successive pixel in the image data.

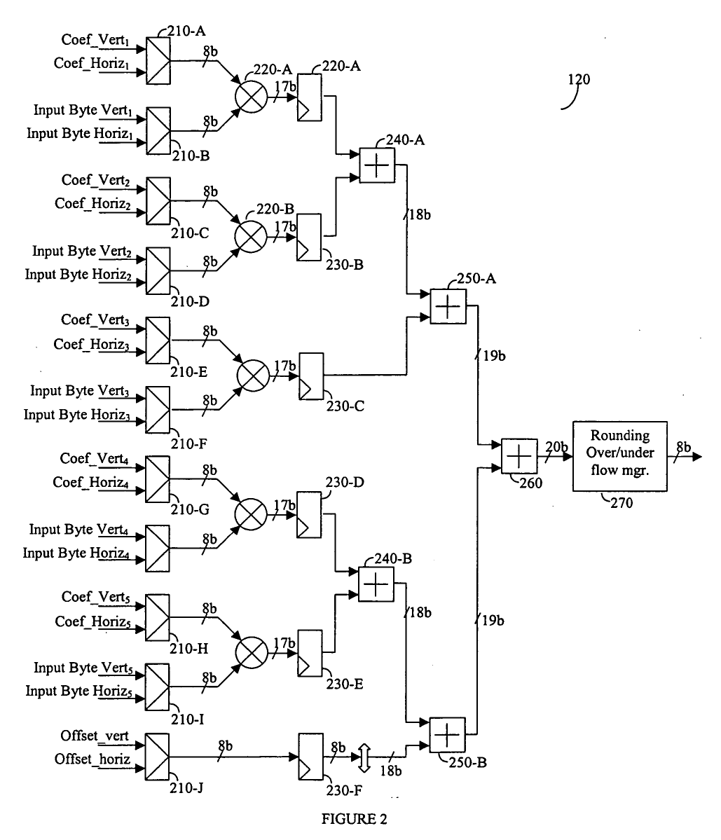

Convolution Operator 120 is described in more detail in FIG. 2 and is further explained below. It is designed to perform a one-dimension (1D) convolution and hence, for performing the full 2D convolution operation, two passes through Convolution Operator 120 are required. More specifically, it is performed by separating the horizontal convolution for each of the three colors from the vertical convolution for each of the three colors, thus performing separable convolution operations. For this purpose a Middle Buffer 130 is used. In the 5×5 matrix example, the Middle Buffer 130 is a 3×5×8 buffer, to hold for each of the three colors 5 bytes (8 bits per byte), resulting from the vertical convolution of five columns.

When processing the data for the center pixel of a 5×5 matrix in the vertical dimension, the output of the Convolution Operator 120 for each five color bytes in a column obtained from the Input Buffer 110 is directed to the Middle Buffer 130 for temporary storage. For 64 bit words in the Input Buffer 110, the results will fill 8 storage locations in the Middle Buffer 130. Then the data in the Input Buffer 110 is overwritten with new data and vertical convolution of the new data proceeds until three color data for five columns has been processed. In general this may or may not involve processing all data currently in the Input Buffer 110. Then the contents of the Middle Buffer 130 are directed to the Convolution Operator 120, color by color, and convolution in the horizontal direction is carried out, with the output of the Convolution Operator 120 being directed to the Output Buffer 150 on convolution of each color for each line.

The process now repeats, this time loading the Input Buffer 110 starting with 64 bit data words that include data for the second line, carrying out convolution in the vertical direction, color by color, and storing the results in the Middle Buffer 130 before overwriting the contents of the Input Buffer 110 with the next appropriate five new 64 bit image data words. Note that each time five lines for each successive center pixel has been processed in the vertical direction and stored in the Middle Buffer 130, input to the Convolution Operator 120 is switched to the Middle Buffer 130 and convolution in the horizontal direction proceeds, with the output of the Convolution Operator 120 being directed to the Output Buffer 150. The function of Output Buffer 150 is to interleave the color component bytes when appropriate and prepare the data to be loaded on the output bus. Output Buffer 150 further operates in conjunction with Input Mask FIFO 140 which provides a mask to the Output Buffer 150 and enables or disables the use of the convolution result on a per pixel basis. This, for example, allows not using the convolution results when sharp edges are required, such as in the case of characters, and instead using the original pixel.

In the above description, processing first in the vertical direction is described, as the exemplary Input Buffer 110 does not hold enough data for five pixels per line. Thus while processing in the vertical direction first is a limitation of the exemplary system and the form of input data, it is not a limitation of the invention itself, as by way of example, a somewhat larger Input Buffer 110 could be used to provide enough data for five pixels per line, and appropriately controlled, could allow processing first in the horizontal direction.

Reference is now made to FIG. 2 where an exemplary and non-limiting implementation of a Convolution Operator 120 is shown. In the preferred embodiment being described, Convolution Operator 120 operates under a control manager that controls the functions of the Convolution Operator 120 as explained below, and as a person skilled in the art would be able to implement, based on the explanation herein. Multiplexers 210 select between the two dimension inputs, i.e., allow the transfer of either the vertical dimension data from the Input Buffer 110 or the horizontal dimension data from the Middle Buffer 130. In the preferred embodiment, the data comprises the required number of bytes, for a 5-by-5 pixel implementation five bytes are used, vertical or horizontal coefficients, a vertical offset, and a horizontal offset. The offset may be optional in either direction, or, in another embodiment of the disclosed invention, with no option for any offset values. Data, coefficients and offsets are, for example, eight bits wide. Coefficients are real numbers, i.e., have positive and negative values, and are fixed point. The fixed-point position can be chosen such that the coefficient range is changed. The most significant bit of the coefficient is a sign bit. With an 8-bit implementation it is therefore possible to have various ranges and resolution within the range. For example, with a one bit sign and seven bit resolution, a range of ]−1,1[ in a resolution of 0.0078125 is selected, in the case of one bit as sign, one bit as dynamic range and six bit resolution, a range of ]−2,2[ in a resolution of 0.015625 is selected, and with a one bit sign, four bit dynamic range, and three bit resolution, a range of ]−16,16[ in a resolution of 0.125 is selected.

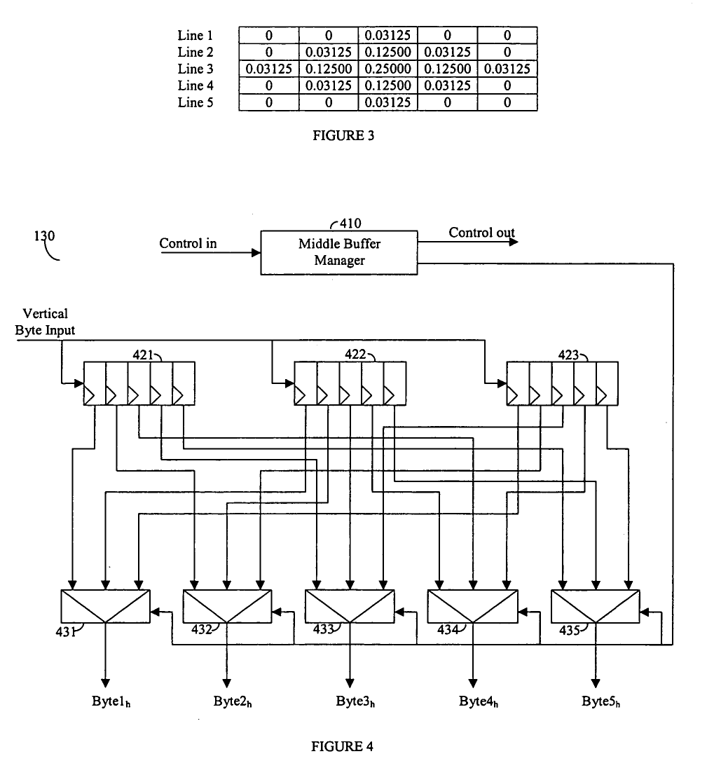

FIG. 3 provides a non-limiting and exemplary coefficient table for a 5-by-5 pixel convolution. It should be noted that the center pixel, which is the pixel for which the convolution is performed, receives in this example the highest coefficient weight. A person skilled in the art could easily identify additional ranges and resolutions based on these examples, including, but not limited to, the adding of bits. It should be noted that the sum of the coefficients should be equal to one in order to preserve data consistency and have a positive output result in the range of ‘0’ to ‘255’. The offsets are integers, preferably in the range of [−128, 127] when coded in eight bits, where one bit is a sign bit and the rest are the dynamic range. They can be, but are not necessarily, one in either or both dimensions.

Multipliers 220 multiply the coefficient value by the data value for each data byte, resulting in a 17 bit data, when 8 bit data are the input. The data is buffered on buffers 230 on a per byte basis. A series of adders 240, 250 and 260, perform an addition of the results, ending with a 20 bit result at the output of adder 260. The offset value, which is an eight bit value, is expanded to the same range of the adder 240-B to enable correct addition in adder 250-B. The rounding overflow and underflow manager sets the maximum output to ‘255’ in the case of an overflow, and to ‘0’ in case of an underflow.

Key to the operation of SCPU 100 is Middle Buffer 130 that stores the temporary results of the convolution in one dimension, in the above example the vertical dimension, and provides the data for the convolution in the other dimension, in the example, the horizontal dimension. Therefore, reference is now made to FIG. 4 where an exemplary and non-limiting implementation of a Middle Buffer 130 in accordance with the disclosed embodiment is shown. While performing convolution in one dimension, in the example the vertical dimension, the output of Convolution Operator 120 is directed to Middle Buffer 130. Middle Buffer 130 comprises three line buffers 421, 422 and 423, corresponding to the color components ‘red’, ‘green’ and ‘blue’, each having room for five pixels. The data is then arranged such that the first byte from each of the line buffers 421, 422, and 423 is provided to multiplexer 431, which will then provide the first byte of the horizontal component, as it is required by Convolution Operator 120 for the processing of the horizontal dimension. Similarly, the second byte from each of the line buffers 421, 422, and 423 is provided to multiplexer 432, which will then provide the first byte of the horizontal component, and so forth.

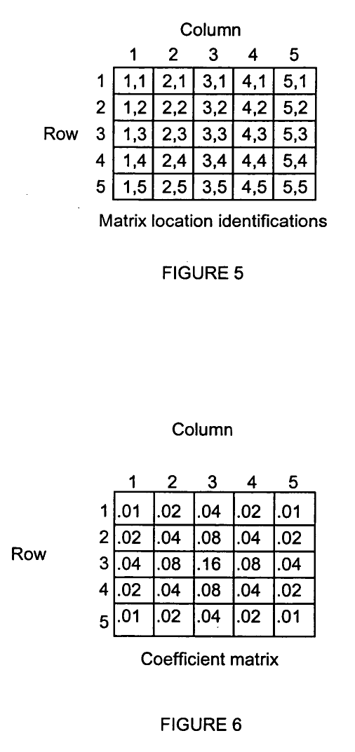

Having now described an exemplary apparatus and method of 2D convolution by successive 1D convolutions, a specific example will be presented. Referring to FIG. 5, any color of any 5×5 matrix may be represented as shown, where the matrix values are identified by a column number followed by a line number. As each column, or alternatively two columns become available from the Input Buffer 110 (any five 64 bit words in the Input Buffer 110 will include all color components for two pixels), convolution of that column or columns in the vertical direction will be carried out and stored in the Middle Buffer 130. For instance for the first column, the value stored in the Middle Buffer 130 will be:

Col. 1

0(1,1)+0(1,2)+0.03125(1,3)+0(1,4)+0(1,5)

As the vertical convolutions are carried out as data in the Input Buffer 110 becomes available, the remaining values stored in the Middle Buffer 130 will be:

Col. 2

0(2,1)+0.03125(2,2)+0.125(2,3)+0.03125(2,4)+0(2,5)

Col. 3

0.03125(3,1)+0.125(3,2)+0.250(3,3)+0.125(3,4)+003125(3,5)

Col. 4

0(4,1)+0.03125(4,2)+0.125(4,3)+0.03125(4,4)+0(4,5)

Col. 5

0(5,1)+5(1,2)+0.03125(5,3)+0(5,4)+0(5,5)

In accordance with the disclosed invention, the 5 coefficient convolution may also include the addition of an offset value to each of the five calculations shown above. Typically the offset value is in a range of [−128, 127] coded into 8 bits, where one bit is a sign and seven bits contain the desired dynamic range.

For each center pixel there are now three groups, each group corresponding to one of the RGB colors, each group comprising of the five values generated in the previous step, as explained above. When these five sets of three (3 colors for each pixel) values are stored in the Middle Buffer 130 for each color of a pixel (15 values total, each 8 bits), “convolution” in the horizontal direction is carried out. This operation simply is the addition of all five values of a color in the Middle Buffer 130 for each color of the pixel to provide a smoothed value for each color, specifically:

Smoothed Value for Each Color of the Center Pixel

0.03125(1,3)+0.03125(2,2)+0.125(2,3)+0.03125(2,4)

+0.03125(3,1)+0.125(3,2)+0.250(3,3)+0.125(3,4)+003125(3,5)

+0.03125(4,2)+0.125(4,3)+0.03125(4,4)+0.03125(5,3)

For the addition, all coefficients provided to the Convolution Operator 120 will be 1.0, with the sum of the coefficients in the final smoothed value also being 1.0 in accordance with the sum of the coefficients in FIG. 3.

This process is repeated for each additional color of the pixel. Once convolution for one center pixel is completed and the smoothed pixel information is provided to the Output Buffer 150, the process is repeated for the next center pixel. In that regard, data remaining in the Input Buffer 110 will include pixel data for two columns of the 5×5 matrix for the next pixel, which may be used before resuming input of data as required to the Input Buffer 110. That input will necessarily include some previously processed data, that is, data for columns that was overwritten in obtaining data for the remaining columns for the prior center pixel.

Thus exemplary SCPU 100 functions by first performing a one dimensional convolution in a vertical direction on a square matrix, i.e., the number of lines and columns are the same, of an odd number of lines from the Input Buffer 110 as data for the respective lines becomes available, for the purpose of performing convolution on the center pixel of the matrix. It further receives vertical and horizontal coefficients to be used with pixels of each of the lines. The coefficients are real numbers and may be defined to provide flexible ranges and resultant resolutions so as to be able to better handle the specific nature of the convolution task at hand. In addition an offset to be used to offset the overall result of the convolution, either upward or downward, as the case may require.

The convolution operation is performed such that first a convolution is performed in one dimension, for example, the vertical dimension. The results of the convolution are stored in a Middle Buffer 130 that is controlled by Middle Buffer Manager 410 to handle the requirement to re-interleave the pixel data as it is output from the first stage of the 1D convolution, i.e., organizing the byte data to be in a sequence of ‘red’, ‘green’, ‘blue’, ‘red’, ‘green’, ‘blue’, and so on and so forth until the entire data is consumed. This organization allows for the reuse of the 1D Convolution Operator 120 for the purpose of performing the convolution in the other dimension, for example, the horizontal dimension. When the second 1D convolution takes place, rather then directing the results to Middle Buffer 130, results are directed to Output Buffer 150. Pixels are output from Output Buffer 150 under the control of an input mask supplied to the Input Mask FIFO 140. This enables SCPU 100 to either output the original pixel if the mask indicates that no convolution is required, or output the pixel after convolution, if so indicated by the supplied mask.

Note that the output of the Convolution Operator 120 will normally be a raster scan sequence of smoothed pixels, with the smoothed image using a 2n+1 matrix being n pixels smaller than the original image at the top, the bottom and at both sides. To provide the smoothed and original pixel information in lockstep so that either may be selected over the other for printing, in addition to appropriate timing, the equivalent pixels in the original image may be blanked out in favor or smoothed pixels, or alternatively automatically passed to the output without smoothing.

Having now described an embodiment of the present invention in detail, other embodiments will become apparent. By way of but one example, if the Input Buffer 110 is expanded to hold three 64 bit words for each of the five lines in the prior example, then the Input Buffer 110 would be large enough to hold data for eight pixels per line, assuring enough data for all vertical convolutions (or allowing horizontal convolution first) without overwriting any data in the Input Buffer 110. Thus after the convolutions for one center pixel are completed, the only 64 bit words that need to be overwritten with new input data or additional columns, if any, are the words containing data for what was column 1 (FIG. 5) or earlier processed columns for which the data is no longer needed.

In another embodiment, the same convolution coefficients are used for each line and the same convolution coefficients are used for every column of the 5-by-5 (or other size) matrix. In the example to follow, the same coefficients are used for both each line and each column. Specifically consider the coefficients:

0.1 0.2 0.4 0.2 0.1 (for each line)

0.1 0.2 0.4 0.2 0.1 (for each column)

While convolution may proceed in either direction first, for purposes of specificity, assume that as in the earlier example, convolution proceeds in the vertical direction first. The five results of the five vertical convolutions, one for each column, will be:

Col. 1

0.1(1,1)+0.2(1,2)+0.4(1,3)+0.2(1,4)+0.1(1,5)

Col. 2

0.1(2,1)+0.2(2,2)+0.4(2,3)+0.2(2,4)+0.1(2,5)

Col. 3

0.1(3,1)+0.2(3,2)+0.4(3,3)+0.2(3,4)+0.1(3,5)

Col. 4

0.1(4,1)+0.2(4,2)+0.4(4,3)+0.2(4,4)+0.1(4,5)

Col. 5

0.1(5,1)+0.2(5,2)+0.4(5,3)+0.2(5,4)+0.1(5,5)

Note that the sum of the coefficients used for each column add up to one, whereas in the prior example, the coefficients for each column add up to less than 1, with the total coefficients for all columns together adding up to 1. In the present example, when the same convolution coefficients are used for the second (horizontal in this example) convolution, a single convolution, the result will be a single value equal to the total sum of respective values in the 5-by-5 matrix of FIG. 5, each multiplied by the respective coefficient in the 5-by-5 coefficient matrix of FIG. 6. Note that the sum of all coefficients in the coefficient matrix of FIG. 6 is 1, as normally desired to avoid resealing of the signals, and is the case in the prior example. Except for the coefficients used, the operation of the system for this embodiment is the same as for the previous embodiment

In the foregoing example, the sum of the coefficients used for each line and the sum of the coefficients used for each column are both equal to 1. This is preferred, assuming it is desired to not rescale the digital values, though is not a limitation of the present invention. In that regard, the scaling of the digital values would be preserved if the total of the coefficients for each line and for each column were not equal to 1, provided the product of the totals was equal to 1. Also in the example, the same coefficients are used for each column as are used for each line, though this too is not a limitation of the invention. Further, the coefficients for each line and the coefficients for each column in this example are both symmetrical about the center coefficient, which symmetry is also not a limitation of the present invention. Accordingly, the values shown are convenient values for purposes of explanation, and for that matter, could be used as default values in an actual system, though as previously mentioned, preferably the coefficient values are variable under program control to achieve the desired result on a respective image.

While a 5 lines time 64 bit input buffer is used in the embodiments disclosed herein, it should be noted that this is merely an exemplary implementation for a case where there is a 64-bit bus supplying the input buffer and hence limiting the bandwidth for the supply of data into the input buffer. Other variations will also become apparent. Also, the present invention may be realized in various ways, though preferably will either be a stand alone integrated circuit or fabricated as part of a larger integrated circuit. Thus while certain preferred embodiments of the present invention have been disclosed and described herein for purposes of illustration and not for purposes of limitation, it will be understood by those skilled in the art that various changes in form and detail may be made therein without departing from the spirit and scope of the invention.

What is claimed is:

1. An image processing apparatus comprising:
apparatus for performing a two dimensional convolution operation by performing a first dimension convolution operation followed by a second dimension convolution operation, said apparatus including:
a one dimensional convolution operator configured to receive input data and respective coefficients and perform a one dimensional convolution;
a middle buffer configured to buffer the results of the first dimension convolution operation of the convolution operator;
the convolution operator being configured to direct the output of the convolution operator for the first dimension operation to the middle buffer and the output of the convolution operator for the second dimension operation to an output of the image processing apparatus; and,
a multiplexer configured to select as an input to the convolution operator, an input to the image processing apparatus for the first convolution operation and an output of said middle buffer for the second convolution operation.

2. The apparatus of claim 1 wherein said one dimensional convolution operator is further configured to receive offset values.

3. The apparatus of claim 1 wherein said apparatus further comprises a pixel output buffer configured to selectively provide a pixel after performing both said first second dimension convolution operations or a corresponding pixel on which convolution has not been performed.

4. The apparatus of claim 3 wherein said pixel output buffer is controlled by an input mask.

5. The apparatus of claim 1 wherein said respective coefficients are coefficients of said first dimension and coefficients of said second dimension.

6. The apparatus of claim 1 wherein the sum of said coefficients taken over both the first and the second dimension is equal to one.

7. The apparatus of claim 6 wherein said coefficients have a dynamic range.

8. The apparatus of claim 1 wherein said first buffer is configured to organize byte data in a repetitive sequence.

9. The apparatus of claim 8 wherein said repetitive sequence is at least the order of colors.

10. The apparatus of claim 9 wherein said colors comprise red, green and blue.

11. An integrated circuit for performing a two dimensional convolution operation comprising:
a first logic circuit being configured to receive input data and respective coefficients and perform a one-dimension convolution operation thereon;
a buffering circuit for the purpose of buffering the output of the first logic circuit for a first convolution of an image; and,
a second logic circuit for selection between data on which convolution in a first dimension is to be performed and data from the buffering circuit on which convolution in a first dimension has been performed.

12. The integrated circuit of claim 11 wherein said first logic circuit is further configured to receive offset values.

13. The integrated circuit of claim 11 wherein said integrated circuit further comprises a pixel output circuit configured to selectively provide a pixel after performing convolution operations in first and second directions or the original pixel.

14. The integrated circuit of claim 13 wherein said pixel output circuit is controlled by an input mask.

15. The integrated circuit of claim 11 wherein said respective coefficients are coefficients of first dimensions and second dimensions.

16. The integrated circuit of claim 11 wherein the sum of said coefficients taken in both first and second directions is equal to one.

17. The integrated circuit of claim 16 wherein said coefficients have a dynamic range.

18. The integrated circuit of claim 11 wherein said buffering circuit is further configured to organize the byte data in a repetitive sequence.

19. The integrated circuit of claim 18 wherein said repetitive sequence is at least the order of colors.

20. The integrated circuit of claim 19 wherein said colors comprise red, green and blue.

21. The integrated circuit of claim 11 wherein said integrated circuit is a stand alone integrated circuit.

22. The integrated circuit of claim 11 wherein said integrated circuit is part of a larger integrated circuit.

23. A method of performing a two dimensional convolution operation comprising:
performing a first dimension convolution operation followed by a second dimension convolution operation by:
receiving a square pixel matrix of an odd number of lines;
receiving first coefficients respective of said first dimension;
performing a one-dimension convolution operation in said first dimension using said pixel matrix and said first coefficients;
storing the results of the convolution of said first dimension in a buffer;
receiving second coefficients respective of said second dimension; and,
repeating said one-dimension convolution operation in said second dimension using said results stored in said buffer and said second coefficients.

24. The method of claim 23 wherein said method further comprises:
receiving a first offset value respective of said first dimension; and,
performing said one-dimension convolution operation further using said first offset value.

25. The method of claim 23 wherein said method further comprises:
receiving a second offset value respective of said second dimension; and,
performing said one-dimension convolution operation further using said second offset value.

26. The method of claim 23 wherein said method further comprises:
receiving an input mask; and,
outputting the original pixel if the input mask has a first value or outputting the convolution result for the pixel if the input mask has a second value.

27. The method of claim 23 wherein the sum of said first coefficients is equal to one.

28. The method of claim 23 wherein the sum of said second coefficients is equal to one.

29. The method of claim 23 wherein said coefficients have a dynamic range.

30. The method of claim 23 wherein said method further comprises organizing the byte data in a repetitive sequence in said buffer.

31. The method of claim 30 wherein said repetitive sequence is at least the order of colors.

32. The method of claim 31 wherein said colors comprise red, green and blue.
